(19) United States
(12) Patent Application Publication
(10) Pub. No.: US 2013/0049259 A1
(43) Pub. Date: Feb. 28, 2013

(54) SYSTEM FOR MANUFACTURING WALL BLOCKS HAVING INTEGRAL NUBS AND BLOCKS THAT UTILIZE BLOCK-CONNECTING DEVICES

(71) Applicant: James E. Hammer, University Place, WA (US)

(72) Inventor: James E. Hammer, University Place, WA (US)

(73) Assignee: Westblock Systems, Inc.

(21) Appl. No.: 13/586,778

(22) Filed: Aug. 15, 2012

Related U.S. Application Data
(60) Provisional application No. 61/527,045, filed on Aug. 24, 2011.

(51) Int. Cl. B29C 39/02

(52) U.S. Cl. 264/299; 425/457

(57) ABSTRACT

Disclosed herein are apparatuses and methods for forming concrete blocks having integral alignment nubs and concrete blocks without integral alignment nubs. In particular embodiments, a mold assembly comprises a mold, a first set of mold shoes for forming the blocks having integral alignment nubs, and a second set of mold shoes for forming the blocks without integral alignment nubs. When a manufacturer desires to manufacture blocks having integral alignment nubs, the mold and the first set of mold shoes are installed in a block-forming machine. When the manufacturer desires to manufacture blocks without integral alignment nubs, the first set of mold shoes are replaced with the second set of mold shoes in the block-forming machine.

### CROSS REFERENCE TO RELATED APPLICATION

The present application claims the benefit of U.S. Provisional Application No. 61/527,045, filed Aug. 24, 2011, which is incorporated herein by reference.

### FIELD

The present application concerns a system that can be used for making wall blocks (e.g., retaining wall blocks).

### BACKGROUND

When wall blocks (e.g., concrete retaining wall blocks) are stacked to form a wall, each course of blocks needs to be properly aligned with the course above and below. To accomplish such alignment, blocks can be formed with integral concrete nubs (or an equivalent structural feature) that mates with or engages a corresponding feature of a block in an adjacent course. For example, each block in a wall can be formed with an integral nub on its upper surface and an opening at its lower surface. When forming a new course of blocks on top of an adjacent lower course, each block of the course being formed is stacked such that the integral nub of a block in the lower course extends into the opening of the block in the newly formed course. The engagement of the nubs with corresponding openings serves as a connection system that interconnects vertically adjacent blocks and resists lateral forces on the wall. Another common alignment and connection system for concrete blocks involves the use of separate alignment pins or plugs (usually made of plastic or fiberglass) that are configured to extend into corresponding cores or openings in the blocks.

Each system described above has associated advantages. Block systems that utilize integral nubs, or equivalent features, are preferred in some markets because they are generally less expensive to manufacture then systems that require alignment pins or plugs. On the other hand, systems that that require alignment pins or plugs are preferred in other markets because the blocks are easier to manufacture, are more durable and provide more construction flexibility. Due to specific market demand for one type of system or the other, it would be desirable for manufacturers to be able to manufacture blocks that utilize both systems. Unfortunately, a block-forming machine containing a mold assembly that is specifically configured to form blocks having integral nubs cannot be used to form similar blocks that utilize connecting pins or plugs, and vice versa, without substantial modification of the mold assembly or an entirely separate mold assembly. Furthermore, if a block-forming machine set up for forming blocks of one type can be modified to form blocks of the other type, the process of modifying the block-forming machine typically is complicated and leads to significant downtime in production because different mold parts must be installed and/or the machine must be re-calibrated. Consequently, most block manufacturers manufacture wall blocks of one type, but not both.

What is needed is an improved block-forming system that can be used to form blocks utilizing both types of alignment/connection systems without substantial modification of the mold assembly and without substantial downtime in the production process.

### SUMMARY

Disclosed herein are apparatuses and methods for forming concrete blocks having integral alignment nubs and concrete blocks without integral alignment nubs. In particular embodiments, a mold assembly comprises a mold, a first set of mold shoes for forming the blocks having integral alignment nubs, and a second set of mold shoes for forming the blocks without integral alignment nubs. When a manufacturer desires to manufacture blocks having integral alignment nubs, the mold and the first set of mold shoes are installed in a block-forming machine, which is operated to form the desired blocks. When the manufacturer desires to manufacture blocks without integral alignment nubs, the first set of mold shoes are replaced with the second set of mold shoes in the block-forming machine. Accordingly, one mold can be used to form both types of blocks. The first and second sets of mold shoes are configured such that significant adjustment of the block-forming machine is not required when replacing the first set of mold shoes with the second set of mold shoes, and vice versa. In particular embodiments, the vertical spacing between the mold shoes and a pallet supporting blocks underneath the mold need not be adjusted when replacing the first set of mold shoes with the second set of mold shoes, and vice versa.

In one representative embodiment, a method of manufacturing dry cast concrete blocks using a concrete block-forming machine and a mold comprises: (1) providing a first set of at least one mold shoe, wherein at least one of the mold shoes of the first set comprises one or more depressions configured to form integral alignment nubs on a concrete block; (2) providing a second set of at least one mold shoe, wherein each mold shoe of the second set has the same horizontal footprint as one of the mold shoes of the first set; (3) mounting the first set of mold shoes above the mold within the concrete block-forming machine; (4) using the concrete block-forming machine with the first set of mold shoes and the mold to form concrete blocks having one or more integral alignment nubs; (5) removing the first set of mold shoes from block-forming machine; (6) mounting the second set of mold shoes above the mold within the block-forming machine; and (7) using the concrete block-forming machine with the second set of mold shoes and the mold to form concrete blocks that are formed without the one or more integral alignment nubs that are formed with the first set of mold shoes.

In another representative embodiment, a method of manufacturing dry cast concrete blocks using a concrete block-forming machine and a mold comprises: (1) providing a first set of one or more mold shoes; (2) providing a second set one or more mold shoes, wherein at least one of the mold shoes of the second set comprises one or more depressions configured to form integral alignment nubs on a concrete block; (3) mounting the first set of mold shoes above the mold within the concrete block-forming machine; (4) using the concrete block-forming machine with the first set of mold shoes and the mold to form concrete blocks having one or more alignment cores that are sized and shaped to receive separate block-connecting elements for interconnecting blocks in a wall; (5) removing the first set of mold shoes from the block-forming machine; (6) mounting the second set of mold shoes above the mold within the block-forming machine; and (7) using the concrete block-forming machine with the second set of mold shoes and the mold to form concrete blocks that are formed with one or more integral alignment nubs and alignment cores, wherein blocks formed with the second set of mold shoes have the same horizontal footprint as blocks formed with the first set of mold shoes.

In another representative embodiment, an assembly for use with a concrete block-forming machine comprises a mold, a first set of one or more mold shoes, and a second set of one or more mold shoes. The mold is configured to form one or more concrete blocks in a block-forming cycle. The first set of one or more mold shoes is configured to be mounted within the block-forming machine, with at least one of the mold shoes of the first set comprising one or more depressions configured to form one or more integral alignment nubs on a concrete block. The second set of one or more mold shoes is configured to be mounted within the block-forming machine in place of the first set of one or more mold shoes, wherein each mold shoe of the second set has the same horizontal footprint as one of the mold shoes of the first set and does not form one or more integral alignment nubs on a concrete block.

The foregoing and other objects, features, and advantages of the invention will become more apparent from the following detailed description, which proceeds with reference to the accompanying figures.

### BRIEF DESCRIPTION OF THE DRAWINGS

FIG. 1 is a perspective view of a mold assembly, according to one embodiment, that can be used in a block-forming machine for manufacturing concrete blocks.

FIGS. 2A and 2B are side views of a block-forming machine being used to manufacture concrete blocks.

FIG. 3A is a bottom plan view of a first set of mold shoes that can be used in a block-forming machine for manufacturing concrete blocks having integral alignment nubs.

FIG. 3B is a bottom plan view of a second set of mold shoes that can be used in a block-forming machine for manufacturing concrete blocks without integral alignment nubs.

FIGS. 4-7 are various views of an exemplary concrete block that can be formed using the mold assembly shown in FIG. 1 and the mold shoes shown in FIG. 3A.

FIGS. 8-10 are various views of another exemplary concrete block that can be formed using the mold assembly shown in FIG. 1 and the mold shoes shown in FIG. 3A.

FIGS. 11-13 are various views of an exemplary concrete block that can be formed using the mold assembly shown in FIG. 1 and the mold shoes shown in FIG. 3B.

FIGS. 14-16 are various views of another exemplary concrete block that can be formed using the mold assembly shown in FIG. 1 and the mold shoes shown in FIG. 3B.

FIGS. 17-22 are various views of an exemplary block-connecting element that can be used to construct a wall from multiple blocks of the type shown in FIGS. 11-16.

FIGS. 23-25 are various views of another exemplary concrete block having integral alignment nubs that can be formed using the principles disclosed herein.

FIGS. 26-28 are various views of another exemplary concrete block without integral alignment nubs that can be formed using the same mold as used to form the block shown in FIGS. 23-25.

FIGS. 29 and 30 are top plan views of two different sizes of core formers that can be used to form alignment cores in blocks.

FIG. 31 is a top plan view of a core former and a removable core former extension secured to the core former.

### DETAILED DESCRIPTION

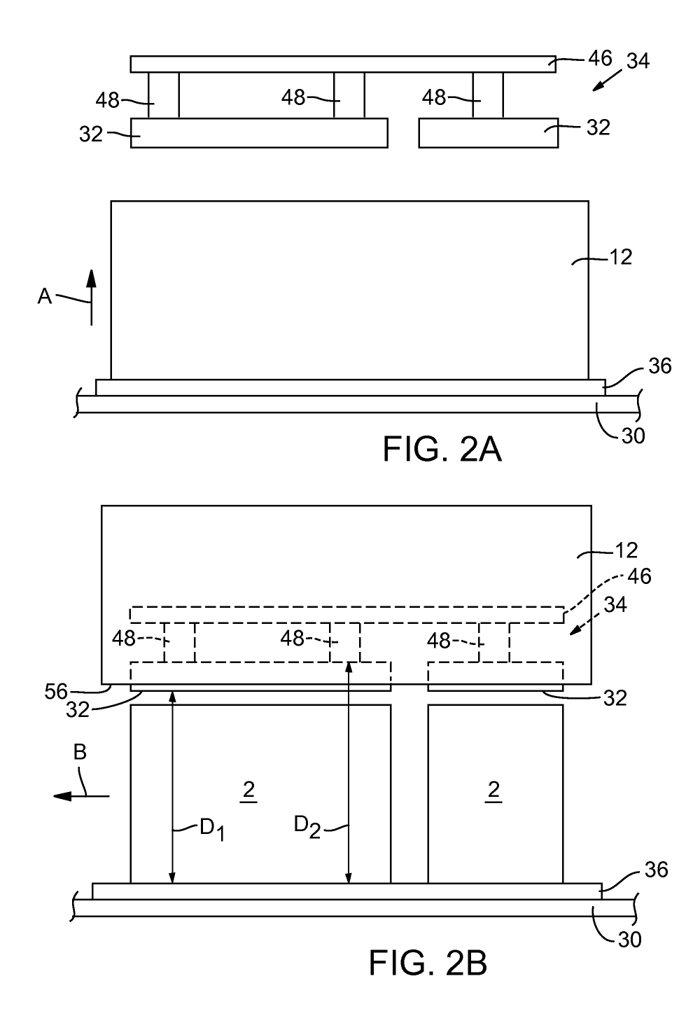

FIGS. 2A and 2B schematically illustrate the operation of a block-forming machine being used to produce one or more “dry-cast” concrete blocks. “Dry-cast” concrete blocks are formed from “zero-slump” concrete, which allows fully formed, uncured blocks to be stripped from a mold and conveyed away from the mold for curing. Block-forming machines such as depicted in FIGS. 2A and 2B can be operated to complete a block-forming cycle several times a minute. One or more blocks can be produced during each block-forming cycle, depending on the size and shape of the mold and the block-forming machine.

Referring to FIG. 2A, in the block-forming machine, a mold 12 is positioned above a conveyor, or carriage, 30. The conveyor 30 is configured to convey a pallet 36 underneath the mold 12 to support uncured blocks being formed in the mold during a block-forming cycle and to support the uncured blocks after they are stripped from the mold and conveyed away from the mold to a location for curing. Positioned above the mold 12 are one or more mold shoes, or presser plates, 32 that assist in pushing or “stripping” uncured blocks from the mold cavities in a vertical direction. The mold shoes 32 also form the upper surface of the blocks and can be configured to form features in the upper surface of the blocks, as further described below. The mold shoes 32 can be a component of a larger head assembly 34 of the block-forming machine. The head assembly 34 can comprise a support member 46 (which can be, for example, a metal plate) and a plurality of elongated plungers 48 extending downwardly from the support member 46. Each mold shoe 32 can be supported at the lower ends of one or more of the plungers 34. The plungers 48 can be formed from sections of steel channel. The head assembly 34 can be operatively coupled to one or more hydraulic rams (not shown) or an equivalent mechanism to effect vertical movement of the head assembly (and therefore the shoes) relative to the mold.

During a block-forming cycle, a pallet 36 is conveyed by the conveyor 30 to a position underneath the open bottom of the mold 12 (as shown in FIG. 2A), and then the cavities within the mold are loaded with a flowable, composite cementitious fill material through the open top of the mold. Composite fill material generally comprises, for example, aggregate material (e.g., gravel or stone chippings), sand, mortar, cement, and water, as generally known in the art. The fill material also may comprise other ingredients, such as pigments, plasticizers, and other fill materials, depending upon the particular application. The mold 12, or the pallet 36, or a combination of both may be vibrated for suitable period of time to assist in the loading of the mold with fill material. The mold shoes 32 can then lowered into the mold cavities against the top of the mass of fill material. The mold shoes desirably are sized so as to provide a slight clearance with the inner surfaces the mold walls when the shoes are lowered into the mold cavities. Additional vibration, together with the pressure exerted by the mold shoes acts to densify the fill material and form the final shape of the blocks.

After blocks are formed within the mold cavities, the formed, uncured blocks are removed from the mold such as by raising the mold 12 (as indicated by arrow A in FIG. 2A), while maintaining the vertical position of the shoes 32 and the pallet 36 so that the blocks are pushed through the open bottom of the mold 12. Alternatively, the blocks can be pushed through the mold 12 by moving the shoes 32 downwardly through the mold, while simultaneously lowering the pallet 36 and maintaining the vertical position of the mold. The pallet 36 can be lowered by lowering a section of the conveyor located directly underneath the mold. The movable section of the conveyor can be operatively coupled to hydraulic pistons or equivalent devices that are operable to lower the conveyor section and the pallet relative to the mold.

FIG. 2B shows two blocks 2 after being stripped from the mold 12. Typically, the mold shoes 32 extend slightly downwardly beyond the lower edge 56 of the mold when the head assembly 34 is at its lowermost position relative to the mold. The block-forming machine is adjusted such that after the blocks 2 are stripped from the mold, there is sufficient clearance, or spacing, D1 between the upper surface of the pallet 36 and the lower surfaces of the mold shoes 32 to allow the blocks 2 to be conveyed away by the conveyor 30 in a horizontal direction B relative to the mold 12. The spacing D1 must be sufficient to allow the blocks 2 to be conveyed in a horizontal direction without the mold shoes 32 contacting the upper surfaces of the blocks 2 or any features formed on the upper surface of the blocks, such as any integral alignment nubs.

Typically, the uncured blocks 2 are conveyed away from the block-forming machine to a location for suitable curing of the blocks before they are stacked on top of other blocks for shipping, as known in the art. The next block-forming cycle begins when the head assembly 34 and the conveyor section below the mold are raised to their respective home positions and an empty pallet 36 is conveyed underneath the mold 12.

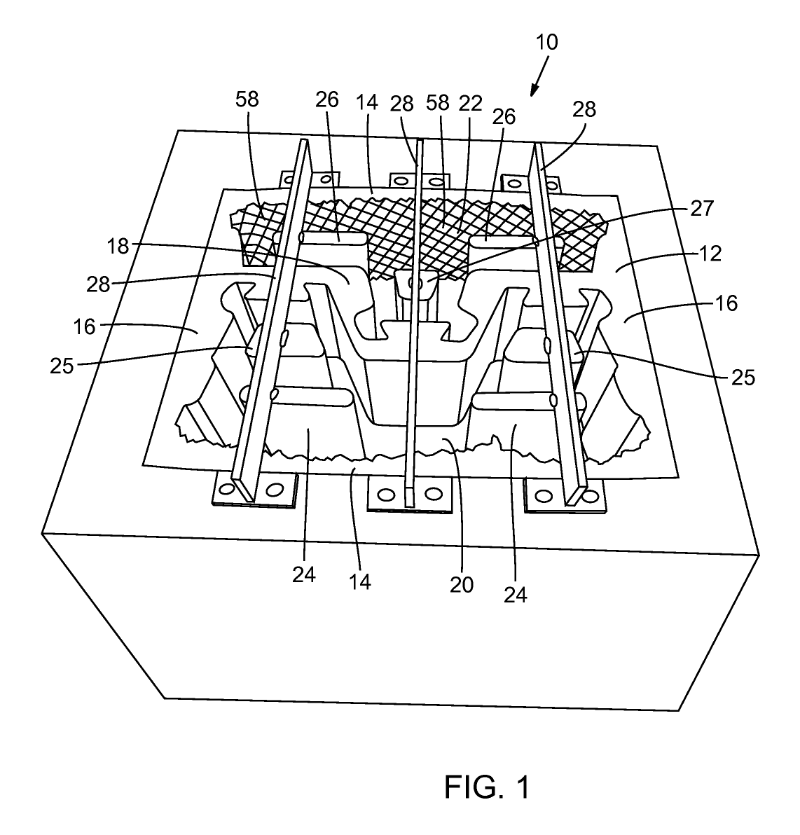

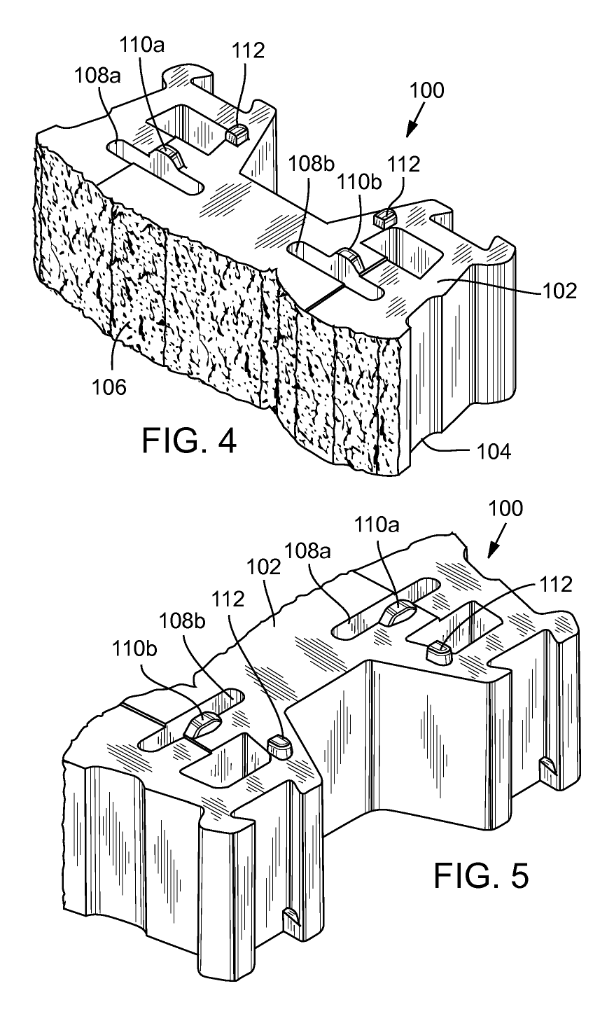

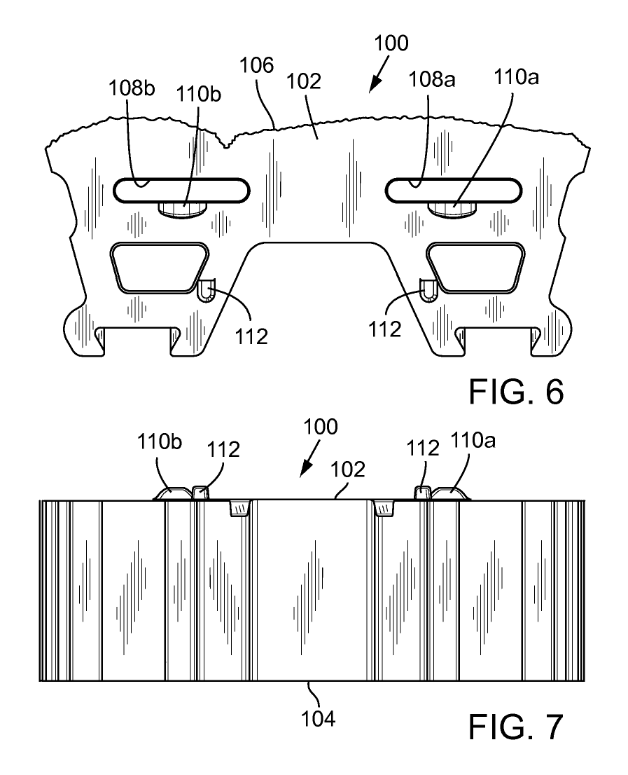

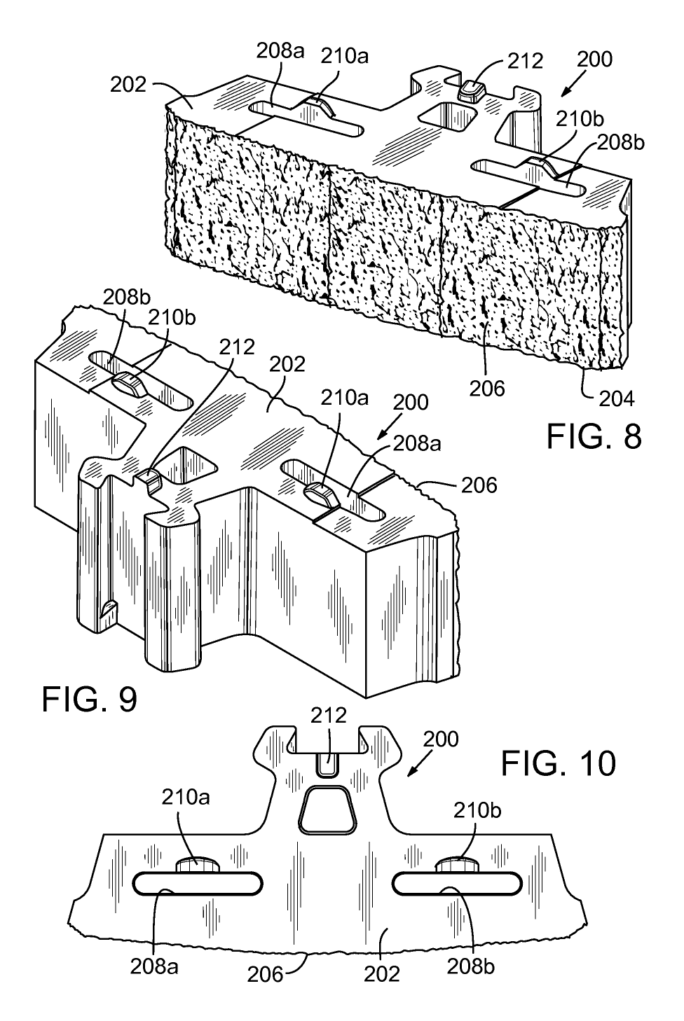

Referring now to FIG. 1, there is a shown a mold assembly 10, according to one embodiment, that can be used in a block-forming machine such as shown in FIGS. 2A and 2B for forming dry cast concrete blocks. The mold assembly 10 in the illustrated embodiment comprises a mold 12 having opposing end walls 14, opposing side walls 16, and a divider wall 18 extending between the side walls 16. The walls 14, 16, 18 define a first mold cavity 20 for forming a first block and a second mold cavity 22 for forming a second block having a different overall shape from the first block. It should be noted that the mold 12 could be modified to have greater or fewer number of mold cavities for forming greater or fewer number of blocks, and the mold can be modified to form blocks of the same size and shape. Disposed within the mold cavities 20, 22 are core formers 24, 25, 26, 27 (also referred to as “cores” in the concrete block industry), which form vertical cores in the blocks. The core formers 24, 25, 26, 27 are connected to and supported by core bars 28 that extend longitudinally above the mold. The core formers 24, 25, 26, 27 and the core bars 28 form a core assembly. The type of block formed within the first mold cavity 20 is shown in FIGS. 4-7 and is further described below. The type of block formed within the second mold cavity 22 is shown in FIG. 8-10 and is further described below.

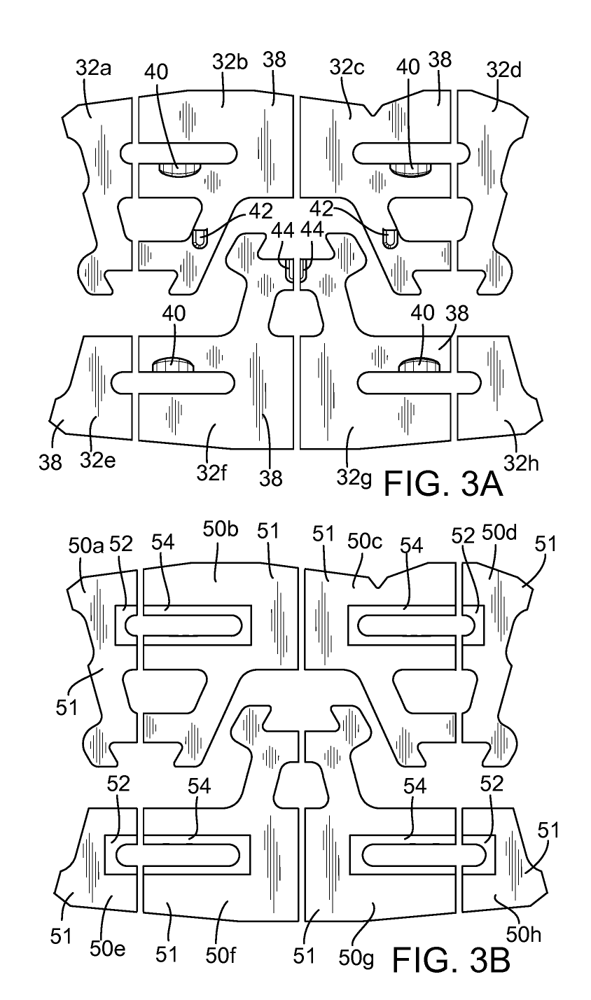

FIG. 3A is a bottom plan view of a first set of mold shoes that can be used with the mold assembly 10. As can be seen, in the illustrated embodiment, four separate mold shoes 32a, 32b, 32c, 32d are sized and shaped to extend downwardly into the first mold cavity 20 via the openings defined between the core bars 28. Similarly, four separate mold shoes 32e, 32f, 32g, 32h are sized and shaped to extend downwardly into the second mold cavity 22 via the openings defined between the core bars 28. One or more of the mold shoes 32a-32h of the first set are configured to form one or more integral alignment nubs on the blocks formed in the mold 12, as further described below. The mold assembly 10 can be placed in a conventional block-forming machine, such as described above and shown in FIGS. 2A and 2B. The mold shoes 32a-32h can be supported above the mold assembly 10 within the block-forming machine, such as by securing the mold shoes to the lower ends of the plungers 48 of the head assembly 34.

The first mold cavity 20 forms a first block 100 (FIGS. 4-7) and the second mold cavity 22 forms a second block 200 (FIGS. 8-10). The two types of blocks 100, 200 can be used together in constructing a wall from multiple blocks 100, 200. Referring to FIGS. 4-7, the block 100 has an upper surface 102, a parallel lower surface 104, a front face 106, and first and second alignment cores 108a, 108b, respectively, that extend the height of the block from the lower surface to the upper surface. Located behind the alignment cores 108a, 108b are respective integral alignment nubs, or projections, 110a, 110b. As used herein, the term “integral” refers to a feature of a block that is formed on the block during the block molding process described below, and is not a piece of material that is formed separately and subsequently attached or mounted to the block. Each alignment core 108a, 108b is sized and shaped to receive a nub from a block in an adjacent lower course when constructing a wall. The block 100 can also be formed with rear integral nubs 112 that allow the blocks to be stacked on top of each on a shipping pallet in a stable manner.

Referring to FIGS. 8-10, the block 200 has an upper surface 202, a parallel lower surface 204, a front face 206, and first and second alignment cores 208a, 208b, respectively, that extend the height of the block from the lower surface to the upper surface. Located behind the alignment cores 208a, 208b are respective integral alignment nubs, or projections, 210a, 210b. Each alignment core 208a, 208b is sized and shaped to receive a nub from a block in an adjacent lower course when constructing a wall. The block 200 can also be formed with a rear integral nub 212 that allow the blocks to be stacked on top of each on a shipping pallet in a stable manner.

When constructing a wall from blocks 100, 200, each course can be formed by placing the blocks side-to-side, alternating between blocks 100 and blocks 200. When forming a new course of blocks over a previously formed course, each block 100 or 200 being added to the wall can be placed over two blocks in the adjacent lower course in a running bond such that it straddles the two blocks in the adjacent lower course and such that the alignment nubs of the blocks in the adjacent lower course extend upwardly into the alignment cores of the block being added to the wall. Because the alignment nubs are offset from the alignment cores towards the rear of the block, the blocks of the newly formed course are set back with respect to the blocks of the adjacent lower course so as to form a wall having a positive batter.

A pair of blocks 100, 200 can be formed using the mold assembly 10 in the following manner. A pallet 36 is conveyed by the conveyor 30 to a position underneath the open bottom of the mold 12 (as shown in FIG. 2A), and then the mold cavities 20, 22 are loaded with a flowable, composite cementitious fill material through the open top of the mold. The mold 12, or the pallet 36, or a combination of both may be vibrated for suitable period of time to assist in the loading of the mold with fill material. Thereafter, mold shoes 32a-32d are lowered into the first mold cavity 20, and mold shoes 32e-32h are lowered into the second mold cavity 22, such that the mold shoes press against the top of the mass of fill material in the mold cavities. The mold shoes desirably are sized so as to provide a slight clearance with the inner surfaces the mold walls when the shoes are lowered into the mold cavities. Additional vibration, together with the pressure exerted by the mold shoes acts to densify the fill material and form the final shape of the blocks.

After blocks are formed within the mold cavities, the formed, uncured blocks 100, 200 are stripped from the mold, such as by raising the mold 12 relative to the shoes, or by moving the shoes downwardly through the mold, while simultaneously lowering the pallet and maintaining the vertical position of the mold. As shown in FIG. 1, one or more inner surfaces of the mold can be formed with a plurality of block-texturing projections 58 that are configured to create a roughened surface texture on adjacent surfaces of the uncured blocks as they are removed from the mold. The roughened surface texture resembles the texture formed on a block surface by conventional splitting. The projections 58 and the technique for forming a roughened surface texture on an uncured block are further described in U.S. Pat. No. 7,100,886, which is incorporated herein by reference. In the illustrated embodiment, the inner surfaces of the end walls 14 include such projections 58 so as to form roughened surface textures on the front faces of the blocks 100, 200 as they are removed from the mold.

Referring again to FIG. 3A, each mold shoe 32a-32h has a lower surface 38. Depressions 40, 42, 44 are formed in the lower surfaces 38 of mold shoes 32b, 32c, 32f, 32g. The alignment nubs 110a, 110b on the block 100 are formed by depressions 40 (FIG. 3A) in the lower surfaces of mold shoes 32b and 32c when the mold shoes are pressed against the upper surface of the block in the mold. The rear nubs 112 are formed by depressions 42 in the lower surfaces of mold shoes 32b and 32c. Similarly, the alignment nubs 210a, 210b on the block 200 are formed by depressions 40 in the lower surfaces of mold shoes 32f, 32g when the mold shoes are pressed against the upper surface of the block in the mold. The rear nub 212 is formed by depressions 44 in the lower surfaces of mold shoes 32f, 32g. The alignment cores 108a, 108b of block 100 are formed by core formers 24 and the alignment cores 208a, 208b of block 200 are formed by core formers 26 (FIG. 1).

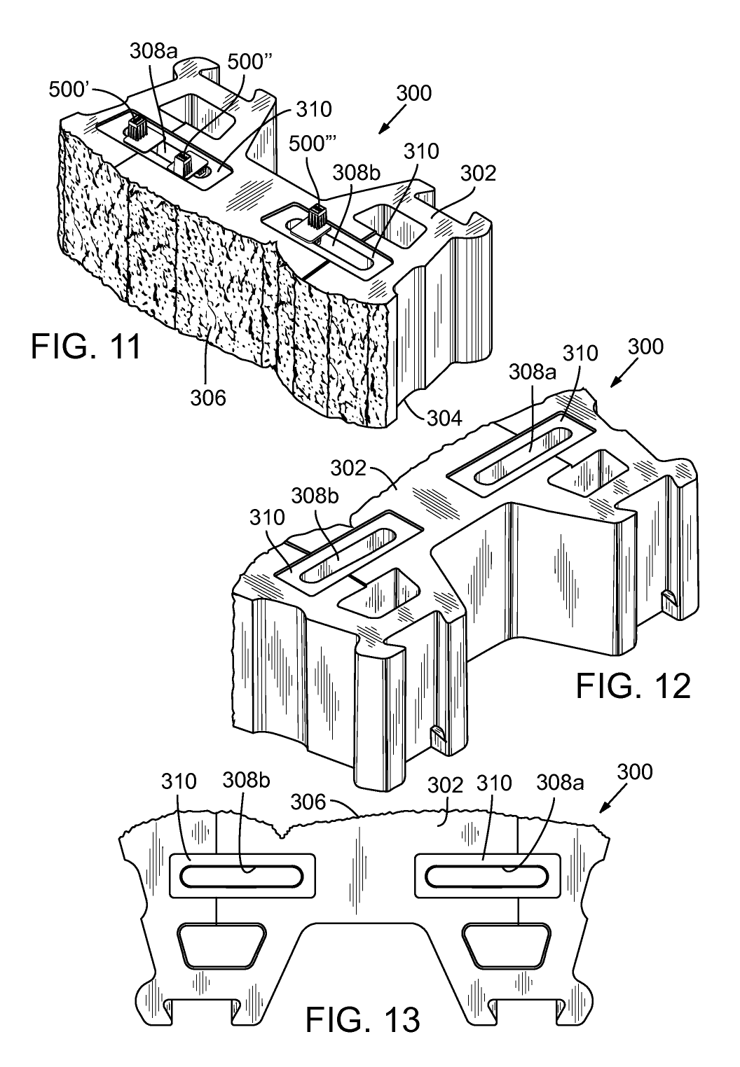

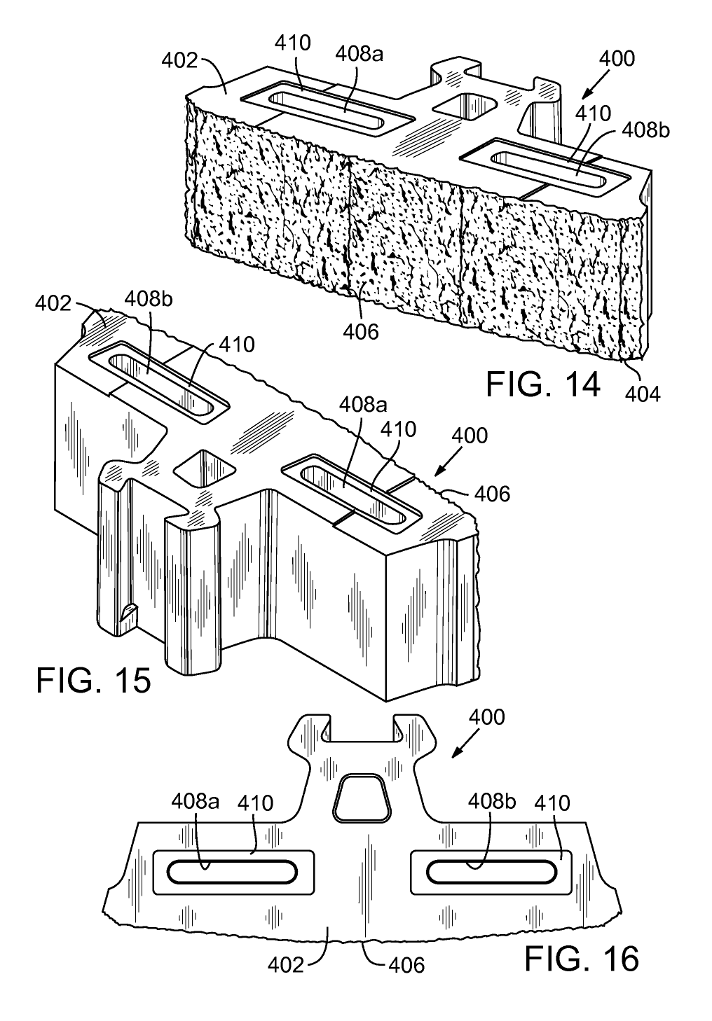

The mold assembly 10 also can be used to form blocks of the same shape as blocks 100, 200 but without integral alignment nubs. Specifically, the mold components shown in FIG. 1 can be used to form a first block 300 (shown in FIGS. 11-13) and a second block 400 (shown in FIGS. 14-16) by replacing the first set of mold shoes shown in FIG. 3A with a second set of one or more mold shoes shown in FIG. 3B. Typically, this can be accomplished by simply removing the bolts that secure the mold shoes 32a-32h to the plungers 48, removing those shoes from the plungers and replacing them with mold shoes 50a-50h (FIG. 3B). Alternatively, the mold shoes 50a-50h can be part of a separate head assembly 34 that can be installed in the block-forming machine. In other words, two separate head assemblies can be provided, with the first head assembly having the first set of mold shoes 32a-32 and the second head assembly having the second set of mold shoes 50a-50h. Thus, when a user decides to begin manufacturing blocks 300, 400, the first head assembly can be removed from the block-forming machine and replaced with the second head assembly. When using relatively small bock-forming machines, it is usually easier to remove and replace the mold shoes from the head assembly. On the other hand, when using relatively larger block-forming machines (such as so called “big board” machines), it is usually easier to replace the entire head assembly rather than individual mold shoes.

Whether replacing the individual mold shoes from the head assembly or replacing the entire head assembly to install the second set of mold shoes, no further adjustments to the mold assembly or the block-forming machine typically are needed to begin manufacturing blocks 300, 400. The blocks 300, 400 are not formed with alignment nubs and instead are configured to be used with separate block-connecting devices or connecting pins for aligning and interconnecting blocks in adjacent courses.

Each of the mold shoes 50a-50h of the second set (FIG. 3B) has the same horizontal footprint as a corresponding mold shoe 32a-32h of the first set (FIG. 3A). As used herein, the term “horizontal footprint” refers to the shape and size of the periphery or outline of an object as seen in a top or bottom plan view of an object. Thus, mold shoe 32a has the same horizontal footprint as mold shoe 50a; mold shoe 32b has the same horizontal footprint as mold shoe 50b; mold shoe 32c has the same horizontal footprint as mold shoe 50c; mold shoe 32d has the same horizontal footprint as mold shoe 50d; mold shoe 32e has the same horizontal footprint as mold shoe 50e; mold shoe 32f has the same horizontal footprint as mold shoe 50f; mold shoe 32g has the same horizontal footprint as mold shoe 50g; and mold shoe 32h has the same horizontal footprint as mold shoe 50h.

When the mold shoes 50a-50h are installed in the block-forming machine, the first mold cavity 20 forms the first block 300 and the second mold cavity 22 forms the second block 400. The two types of blocks 300, 400 can be used to together in constructing a wall from multiple blocks 300, 400. As can be seen, block 300 has the same horizontal footprint as block 100 and block 400 has the same horizontal footprint as block 200. In addition, block 300 has the same overall shape and size as block 100 except for the different features formed in the upper surfaces of the blocks due to the different mold shoes used to form each block. Similarly, block 400 has the same overall shape and size as block 200 except for the different features formed in the upper surfaces of the blocks due to the different mold shoes used to form each block.

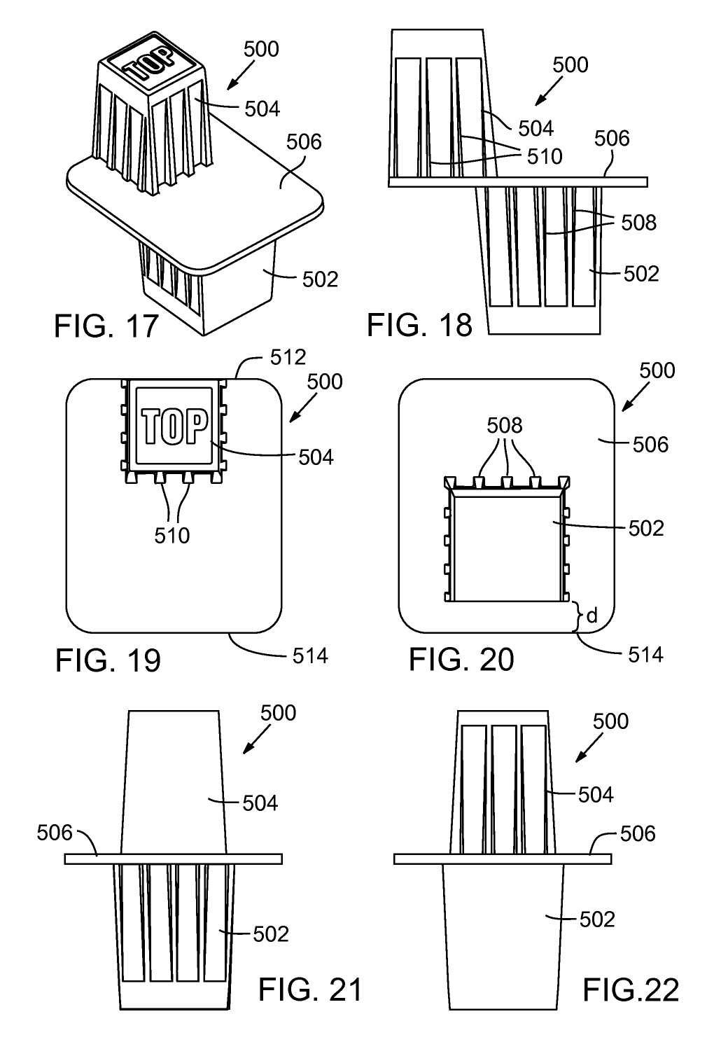

As shown in FIGS. 11-13, the block 300 has an upper surface 302, a parallel lower surface 304, a front face 306, and first and second alignment cores 308a, 308b, respectively, that extend the height of the block from the lower surface to the upper surface. The alignment cores 308a, 308b are configured to received block-connecting elements 500 (FIGS. 17-22) for interconnecting vertically adjacent blocks, as further described below. The block 300 can also be formed with recessed portions 310 surrounding the alignment cores at the upper surface 302 of the block. As shown in FIGS. 14-16, the block 400 has an upper surface 402, a parallel lower surface 404, a front face 406, first and second alignment cores 408a, 408b, respectively, that extend the height of the block from the lower surface to the upper surface, and recessed portions 410 that surround the alignment cores at the upper surface 402 of the block.

The alignment cores 308a, 308b of block 300 are formed by core formers 24 and the alignment cores 408a, 408b of block 400 are formed by core formers 26. The recessed portions 310, 410 on the upper surfaces of the blocks are formed by low profile projections 52, 54 on the lower surfaces 51 of mold shoes 50a-50h (FIG. 3B). In particular embodiments, the projections 52, 54 extend about 1/8 inch from the lower surfaces 51 of the mold shoes. Since the alignment cores (formed by existing core formers 24, 26) are used for receiving block-connecting elements when constructing a wall, no additional core formers or mold components are needed when converting the mold assembly for making blocks 300, 400.

Moreover, the mold shoes 50a-50h are substantially flat and do not include any projections or surface features for forming pins holes or channels for receiving block-connecting devices that would require re-calibration of the position of the conveyor 30 relative to the mold 12 and the mold shoes. Explaining further, in many block-forming machines, the lower surfaces of the mold shoes are closest to the upper surfaces of the blocks as they are being conveyed away from the mold. When the first set of mold shoes are installed in the block-forming machine to form blocks 100, 200, there is a minimum spacing D1 (FIG. 2B) between the upper surface of the pallet 36 and the lower surfaces of the mold shoes 32a-32h. The spacing D1 is set such that the blocks can be conveyed away in a horizontal direction after being stripped from the mold without the mold shoes contacting the integral nubs formed on the upper surface of the block. After removing mold shoes 32a-32h and installing mold shoes 50a-50h, the spacing D1 between the upper surface of the pallet 36 and the lower surfaces of the mold shoes 50a-50h is still sufficient to allow the conveyor 30 to convey formed blocks 300, 400 in a horizontal direction away from the mold without any adjustments to the conveyor or the mold. This is due to the fact that the mold shoes 50a-50h do not have any relatively long projections or extensions that form features in the upper surface of the block, which would otherwise require adjustment of the block-forming machine to increase the distance D1 between the pallet and the lower surfaces of the mold shoes. The only projections on mold shoes 50a-50h are low profile projections 52, 54, which are smaller in height than the depth of the depressions 40, 42 on the first set of mold shoes 32a-32h and the height of the integral nubs on the blocks 100, 200. Because the spacing D1 is sufficient to allow integral nubs 110, 112, 210, 212 on blocks 100, 200 to pass under the mold shoes 32a-32h, the spacing D1 is also sufficient to allow the blocks 300, 400 to pass under the projections 52, 54 of the mold shoes 50a-50h.

As can be appreciated, a manufacturer can easily convert the block-forming machine from a first configuration for forming blocks with integral nubs (or equivalent features) to a second configuration for forming blocks that utilize separate block-connecting devices, and vice versa, with little down time. As noted above, converting the machine from one configuration to the other only can be accomplished by simply replacing one set of mold shoes with the other, either by removing and replacing individual mold shoes from the head assembly or by removing the existing head assembly and replacing it with one equipped with a different set of mold shoes.

In particular embodiments, the spacing D1 between the upper surface of the pallet 36 and the lower surfaces of the mold shoes is the same in both configurations; that is, the spacing D1 when the first set of mold shoes 32a-32h are installed is the same as the spacing D1 when the second set of mold shoes 50a-50h are installed in the block-forming machine. Stated differently, the maximum vertical spacing between a pallet underneath the mold and the first set of mold shoes is the same as the maximum vertical spacing between a pallet underneath the mold and the second set of mold shoes. As used herein, the spacing D1 is measured between the upper surface of the pallet 36 and the lower surfaces 38, 51 of the mold shoes, which are those surfaces of the mold shoes that form the upper surfaces of the blocks (not the portions of the mold shoes that form the nubs and recesses in the upper surfaces of the blocks, such as depressions 40, 42, 44 or projections 52, 54).

In further embodiments, the spacing D2 (FIG. 2B) when the first set of mold shoes 32a-32h are installed is the same as the spacing D2 when the second set of mold shoes 50a-50h are installed in the block-forming machine. The spacing D2 is the distance measured from the upper surface of the pallet 36 to the lower ends of the plungers 48.

FIGS. 17-22 show one example of a block-connecting element that can be used with blocks 300, 400 in the construction of a wall. The block-connecting element 500 can be referred to as a “three-way” block-connecting element (or “three-way” alignment plug) because it can be positioned in three different positions within an alignment core of a block to permit vertical, set forward, or set back placement of blocks in a course relative to the blocks in an adjacent lower course, as further described below.

As shown in FIGS. 17-22, the block-connecting element 500 comprises a lower portion, or projection, 502, an upper portion, or projection, 504, and an intermediate flange portion 506 separating the upper and lower portions. The lower portion 502 can be formed with vertically extending, spaced-apart ribs 508 that extend outwardly from one or more sides of the lower portion (e.g., in the illustrated embodiment, the ribs 508 are formed on three sides of the lower portion). The ribs 508 desirably taper in height extending in a direction from the flange portion 506 to the lower end of the lower portion 502. When inserted into a block, the ribs 508 can contact one or more inner surfaces of a core of the block to assist in frictionally retaining the block-connecting element within the block. Likewise, the upper portion 504 can be formed with vertically extending, spaced-apart ribs 510 that extend outwardly from one or more sides of the upper portion (e.g., in the illustrated embodiment, the ribs 510 are formed on three sides of the upper portion). The ribs 510 desirably taper in height extending in a direction from the flange portion 506 to the upper end of the upper portion 504. When inserted into a block, the ribs 510 can contact one or more inner surfaces of a core of the block to assist in frictionally retaining the block-connecting element within the block.

The upper portion 504 is horizontally offset from the lower portion 502; thus, the upper portion 504 is located closer to a forward edge 512 of the flange portion 506 and the lower portion 502 is located closer to a rear edge 514 of the flange portion 506. In the illustrated embodiment, the upper portion 504 is aligned with the forward edge 512 while the lower portion 502 is spaced slightly from the rear edge 514 a distance d.

FIG. 11 shows the three positions of the block-connecting element 500 in a block (e.g., block 300). Block-connecting element 500′ is in a neutral position in which the upper portion 504 is vertically aligned with the core 308a for constructing a substantially vertical wall (all of the courses are vertically aligned without a batter). As shown, the recessed portioned 310 is sized to receive the flange portion 506 such that it sits flush or slightly below the upper surface of the block. When constructing a vertical wall, a block-connecting element 500 is positioned in a neutral position in cores 308a, 308b of each block 300 and in cores 408a, 408b of each block 400 of the previously laid course. When forming the next course of blocks, each block 300 or 400 being added to the wall can be placed over two blocks in the adjacent lower course in a running bond such that the upper portion 504 of each block-connecting element extends upwardly into an alignment core of a block in the newly formed course. Because the lower portion 502 and the upper portion 504 of each block-connecting element 500 is vertically aligned with respective alignment cores of a block below and of a block above, the blocks interconnected by the block-connecting elements are vertically aligned.

Block-connecting element 500″ in FIG. 11 is in a forward position in which the upper portion 504 is offset from the alignment core 308a toward the front face 306 of the block for constructing a wall with a negative batter. When constructing a wall with a negative batter, a block-connecting element 500 is positioned in a forward position in cores 308a, 308b of each block 300 and in cores 408a, 408b of each block 400 of the previously laid course. When forming the next course of blocks, each block 300 or 400 being added to the wall can be placed over two blocks in the adjacent lower course in a running bond such that the upper portion 504 of each block-connecting element extends upwardly into an alignment core of a block in the newly formed course. Because the upper portion 504 of each block-connecting element 500 is offset from the alignment cores of the previously laid course in a forward direction, the blocks of the newly formed course are set forward with respect to the blocks of the adjacent lower course.

Block-connecting element 500′″ in FIG. 11 is in a rearward position in which the upper portion 504 is offset toward the rear of the block for constructing a wall with a positive batter. When constructing a wall with a positive batter, a block-connecting element 500 is positioned in a rearward position in cores 308a, 308b of each block 300 and in cores 408a, 408b of each block 400 of the previously laid course. When forming the next course of blocks, each block 300 or 400 being added to the wall can be placed over two blocks in the adjacent lower course in a running bond such that the upper portion 504 of each block-connecting element extends upwardly into an alignment core of a block in the newly formed course. Because the upper portion 504 of each block-connecting element 500 is offset from the alignment cores of the previously laid course in a rearward direction, the blocks of the newly formed course are set back with respect to the blocks of the adjacent lower course.

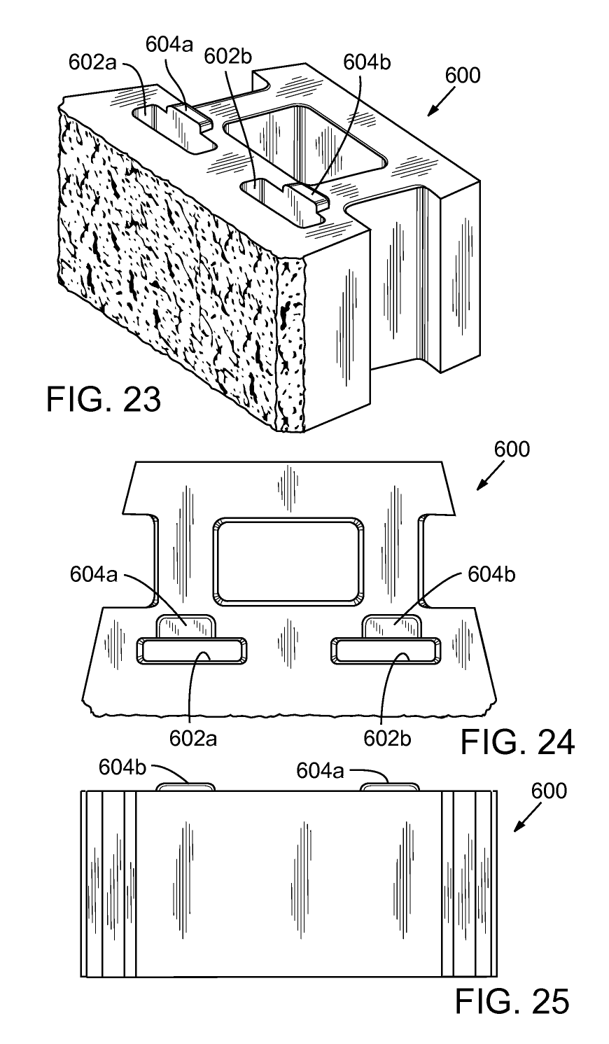

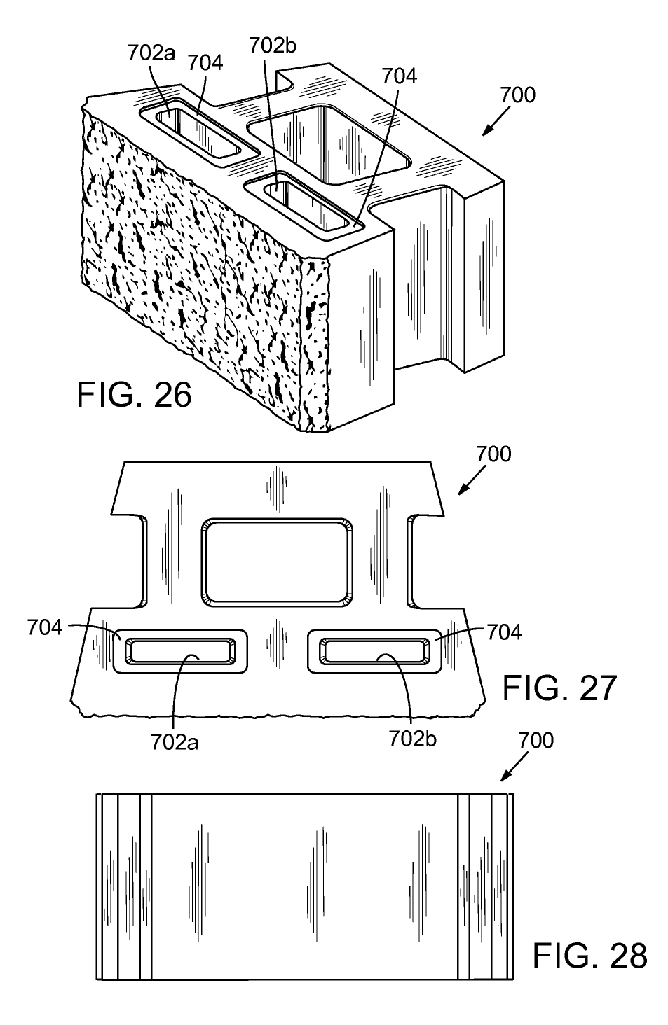

The concepts and features described above pertaining to a system for manufacturing blocks having integral nubs and blocks without integral nubs can be used for making blocks of virtually any shape. For example, FIGS. 23-25 show a block 600 having alignment cores 602a, 602b and integral nubs 604a, 604b. FIGS. 26-28 show a block 700 formed with alignment cores 702a, 702b. The block 700 has the same overall size and shape of the block 600 except that the block 700 does not have any alignment nubs. The block 700 also can be formed with recessed portions 704 surrounding the alignment cores for receiving the flange portions 506 of block-connecting elements 500 inserted into the alignment cores. A single mold having a single set of core formers (for forming the cores in the blocks) can be used to form both the block 600 and the block 700. The mold assembly can be provided with a first set of mold shoes for forming blocks 600 and a second set of mold shoes for forming blocks 700. To convert the mold assembly from a first configuration adapted to form blocks 600 to a second configuration adapted to form blocks 700, and vice versa, all that is required is to remove the existing mold shoes and replace them with the other set of mold shoes.

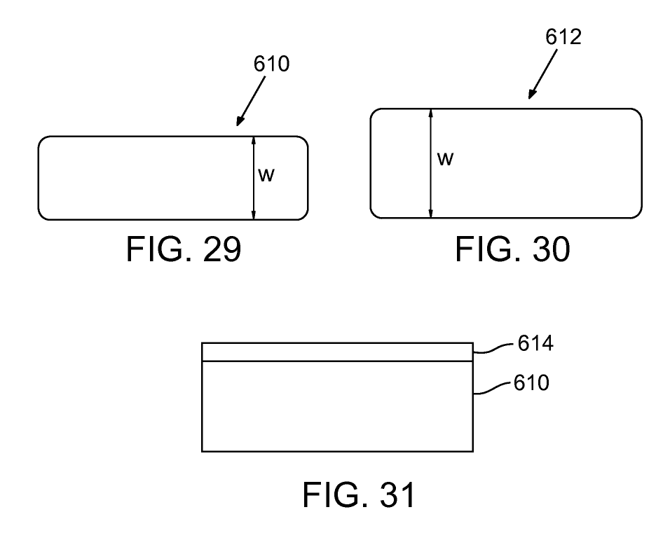

In some embodiments, it may be desirable to provide a first set of core formers for forming one or more blocks having alignment nubs and a second set of core formers for forming one or more blocks without alignment nubs (each set of core formers can be part of a respective core assembly comprising core bars and the core formers secured to the core bars). For example, the integral alignment nubs on a block may require a deeper alignment core to permit insertion of the alignment nubs into the alignment cores of a block in an adjacent course (the “depth” of the alignment core being measured in a direction extending from the front to the rear of the block) compared to a similar block that utilizes block-connecting elements to interconnect blocks in adjacent courses. In such a case, the core formers used for forming the alignment cores of the blocks having integral alignment nubs would be wider (front to back) than the core formers used for forming the alignment cores of the blocks without alignment nubs that utilize block-connecting elements. FIG. 29 is a top plan view of a core former 610 that can be used to form an alignment core 702a, 702b of block 700. FIG. 30 is a top plan view of a core former 612 that can be used for form an alignment core 602a, 602b of block 600. As can be seen, the core former 612 has a greater width W than that of the core former 610, and therefore the block 600 would have deeper cores than the block 700.

In alternative embodiments, rather than providing two different sets of core formers for each type of block, a removable core former extension can be secured to an existing core former to increase the size of the alignment core formed in the block. For example, FIG. 31 shows core former 610 having an extension 614 secured (e.g., bolted) to the core former 610. The core former 610 can be used without the extension to form a relatively narrow alignment core in a block. Where a deeper alignment core is needed, the extension 614 can be secured to the core former 610. An extension 614 can be provided for each core former 610 of the mold assembly.

### General Considerations

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods.

As used herein, the terms “a”, “an” and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

As used herein, the term “coupled” generally means physically coupled or linked and does not exclude the presence of intermediate elements between the coupled items absent specific contrary language.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A method of manufacturing dry cast concrete blocks using a concrete block-forming machine comprising a mold, the method comprising:
providing a first set of at least one mold shoe, wherein at least one of the mold shoes of the first set comprises one or more depressions configured to form integral alignment nubs on a concrete block;
providing a second set of at least one mold shoe, wherein each mold shoe of the second set has the same horizontal footprint as one of the mold shoes of the first set;
mounting the first set of mold shoes above the mold within the concrete block-forming machine;
using the concrete block-forming machine with the first set of mold shoes and the mold to form concrete blocks having one or more integral alignment nubs;
removing the first set of mold shoes from block-forming machine;
mounting the second set of mold shoes above the mold within the block-forming machine; and
using the concrete block-forming machine with the second set of mold shoes and the mold to form concrete blocks that are formed without the one or more integral alignment nubs that are formed with the first set of mold shoes.

2. The method of claim 1, wherein the concrete blocks formed with the second set of mold shoes are formed with one or more cores extending the height of the blocks, the cores being configured to receive separate block-connecting elements that interconnect vertically adjacent blocks when the blocks are stacked on top of each other.

3. The method of claim 1, wherein:
the mold includes one or more core formers;
the concrete blocks formed with the first set of mold shoes have one or more integral alignment nubs and one or more vertical cores formed by the core formers, the vertical cores being configured such that when multiples of the blocks with integral alignment nubs are arranged in stacked courses, the integral alignment nubs of the blocks in one course can extend into corresponding cores of the blocks of another course.

4. The method of claim 3, wherein the concrete blocks formed with the second set of mold shoes having one or more vertical cores formed by the core formers but without integral alignment nubs, the vertical cores being configured such that when multiples of the blocks without integral alignment nubs are arranged in stacked courses, separate block-connecting elements can extend into the cores of the blocks in one course and into corresponding cores of the blocks of another course.

5. The method of claim 1, wherein the concrete blocks formed with the first set of mold shoes have the same horizontal footprint mold as the concrete blocks formed with the second set of mold shoes.

6. The method of claim 1, wherein blocks formed by the block-forming machine are supported on pallets as the blocks are removed from the mold, wherein the maximum vertical spacing between a pallet underneath the mold and the first set of mold shoes is the same as the maximum vertical spacing between a pallet underneath the mold and the second set of mold shoes.

7. The method of claim 1, wherein blocks formed by the block-forming machine are conveyed away from the mold by a conveyor after being removed from the mold, wherein the section of the conveyor underneath the mold is not adjusted between the time the block-forming machine is used to make blocks with integral alignment nubs and the time the block-forming machine is used to make blocks without the integral alignment nubs.

8. The method of claim 1, wherein:
using the concrete block-forming machine with the first set of mold shoes and the mold to form concrete blocks having one or more integral alignment nubs comprises forming one or more uncured concrete blocks in the mold and stripping the one or more uncured concrete blocks from the mold by moving the mold vertically relative to the first set of mold shoes, or vice versa; and
using the concrete block-forming machine with the second set of mold shoes and the mold to form concrete blocks comprises forming one or more uncured concrete blocks in the mold and stripping the one or more uncured concrete blocks from the mold by moving the mold vertically relative to the second set of mold shoes, or vice versa.

9. The method of claim 8, wherein each of the one or more concrete blocks formed with the first set of mold shoes has the same horizontal footprint as one of the one or more concrete blocks formed with the second set of mold shoes.

10. The method of claim 1, wherein:
mounting the first set of mold shoes within the concrete block-forming machine comprises mounting the first set of mold shoes to a head assembly of the concrete block-forming machine;
removing the first set of mold shoes from the block-forming machine comprises removing the first set of mold shoes from the head assembly; and
mounting the second set of mold shoes within the block-forming machine comprises mounting the second set of mold shoes to the head assembly.

11. The method of claim 1, wherein:
mounting the first set of mold shoes within the concrete block-forming machine comprises mounting a first head assembly having the first set of mold shoes in the concrete block-forming machine;
removing the first set of mold shoes from the block-forming machine comprises removing the first the head assembly from the block-forming machine; and
mounting the second set of mold shoes within the block-forming machine comprises mounting a second head assembly having the second set of mold shoes in the concrete block-forming machine.

12. A method of manufacturing dry cast concrete blocks using a concrete block-forming machine comprising a mold, the method comprising:
providing a first set of one or more mold shoes;
providing a second set one or more mold shoes, wherein at least one of the mold shoes of the second set comprises one or more depressions configured to form integral alignment nubs on a concrete block;
mounting the first set of mold shoes above the mold within the concrete block-forming machine;
using the concrete block-forming machine with the first set of mold shoes and the mold to form concrete blocks having one or more alignment cores that are sized and shaped to receive separate block-connecting elements for interconnecting blocks in a wall;
removing the first set of mold shoes from the block-forming machine;
mounting the second set of mold shoes above the mold within the block-forming machine; and
using the concrete block-forming machine with the second set of mold shoes and the mold to form concrete blocks that are formed with one or more integral alignment nubs and alignment cores, wherein blocks formed with the second set of mold shoes have the same horizontal footprint as blocks formed with the first set of mold shoes.

13. The method of claim 12, wherein each mold shoe of the first set has the same horizontal footprint as one of the mold shoes of the second set.

14. The method of claim 12, wherein blocks formed by the block-forming machine are supported on pallets as the blocks are removed from the mold, wherein the maximum vertical spacing between a pallet underneath the mold and the first set of mold shoes is the same as the maximum vertical spacing between a pallet underneath the mold and the second set of mold shoes.

15. The method of claim 12, wherein blocks formed by the block-forming machine are conveyed away from the mold by a conveyor after being removed from the mold, wherein the section of the conveyor underneath the mold is not adjusted between the time the block-forming machine is used to make blocks with integral alignment nubs and the time the block-forming machine is used to make blocks without the integral alignment nubs.

16. The method of claim 12, wherein the mold includes one or more core formers that form the alignment cores in the blocks.

17. The method of claim 12, wherein:
a first set of one or more core formers are used to form the alignment cores in the blocks formed with the first set of mold shoes; and
a second set of one or more core formers are used to form the alignment cores in the blocks formed with the second set of mold shoes.

18. An assembly for use with a concrete block-forming machine, the assembly comprising:
a mold configured to form one or more concrete blocks in a block-forming cycle;
a first set of one or more mold shoes configured to be mounted within the block-forming machine, at least one of the mold shoes of the first set comprising one or more depressions configured to form one or more integral alignment nubs on a concrete block; and
a second set of one or more mold shoes configured to be mounted within the block-forming machine in place of the first set of one or more mold shoes, wherein each mold shoe of the second set has the same horizontal footprint as one of the mold shoes of the first set and does not form one or more integral alignment nubs on a concrete block.

19. The assembly of claim 18, wherein the mold comprises one or more core formers that form one or more vertical cores in concrete blocks formed using the first set of one or more mold shoes and the second set of one or more mold shoes.

20. The assembly of claim 18, further comprising:
a first head assembly adapted to be mounted in the block-forming machine, the first set of one or more mold shoes being mounted to plungers of the first head assembly; and
a second head assembly adapted to be mounted in the block-forming machine, the second set of one or more mold shoes being mounted to plungers of the second head assembly.
